(19) United States
(12) Patent Application Publication
(10) Pub. No.: US 2006/0218037 A1
(43) Pub. Date: Sep. 28, 2006

(54) Method of conducting waste collection & advertising business

(76) Inventor: Sherman T. Rogers, Shelby Township, MI (US)

Correspondence Address: Sherman T. Rogers, 4700 Regina Drive, Shelby Township, MI, 48316, US

(21) Appl. No.: 11/090,355

(22) Filed: Mar. 28, 2005

(51) Int. Cl. G06Q 99/00; G07G 1/14; G06Q 30/00

(52) U.S. Cl. 705/14; 705/1

(57) ABSTRACT

A method of providing trash collection services and advertising using a container that is leased and licensed for advertising and informational display. The transportable trash container is leased to and located at a commercial enterprise where it is used both for temporary storage of trash and advertising of products or services offered by the enterprise. The transportable trash container is delivered to the commercial location where the lessee desires advertising and trash collection.

### BRIEF SUMMARY OF THE INVENTION

1. Field of Invention

This invention relates to a method of doing business. More specifically, this invention relates to a method of providing trash collection and advertising services.

2. Summary of the Invention

This invention relates to a method of doing business combining trash collection services with advertising.

### BACKGROUND OF INVENTION

The use of trash containers for advertising has a long history in prior art patents. An early example is contained in U.S. Pat. No. 757,403 entitled Advertising Waste Paper Box issued Apr. 12, 1904 to Samuel Leveen. The Leveen patent shows a trash receptacle having electrically illuminated advertising panels.

Other similar prior art patents, including U.S. Pat. No. 4,827,645, entitled Illuminated Trash Receptacle issued May 9, 1989, relating to the use of trash containers for advertising also exist.

Commonly, trash haulers own transportable trash containers of various sizes, often large, which they lease and license for temporarily storing trash generated by a commercial enterprise. Periodically, the trash haulers empty and service the containers. Upon expiration of the lease/license, the owner retakes possession of the containers.

It is usual for an owner of transportable trash containers to lease such containers to lessees for the temporary storage of trash. Normally, the owner of the container periodically services, i.e., empties, the containers to maintain sanitary conditions and provide for future trash storage.

In some, even many, instances, the customer leasing the container for the temporary storage of trash also owns or operates a commercial enterprise that offers products or services to the public. The transportable trash container is used to temporarily store trash and waste materials generated by the commercial enterprise and other sources.

This invention relates to a method of doing business which combines the waste and advertising businesses.

In accordance with the present invention, the transportable trash container is both leased for the temporary storage of waste and licensed for use to provide advertising space. The use for advertising can be licensed either to the party leasing the transportable trash container for temporary waste storage or to another party.

This invention provides the owner of the transportable trash container, the lessee of the container, and the licensee of the right to use the transportable trash containers for advertising with an economic advantage.

Thus it is a principle object of this invention to lease and license the use transportable trash containers for advertising as well as temporary trash storage purposes. Specifically, the lessee of the containers or a third party would also be licensed to use the containers for advertising purposes. Thus, both the owner, lessee, and advertising licensee of the transportable trash containers have an opportunity to obtain the benefit of having a temporary trash storage container and the additional benefit of using the transportable trash containers to advertise and publicize products or services.

### BRIEF DESCRIPTION OF THE DRAWING

FIG. 1 shows a transportable trash container with an advertising display.

FIG. 2 shows a special automotive vehicle with a transportable trash container in place.

FIG. 3 shows a transportable trash container located at an advertising and trash collection site.

### DETAILED DESCRIPTION OF THE INVENTION

This invention relates to a method of doing business. It combines two commercial activities, i.e., trash storage and removal service and advertising, into a single business practice that provides potentially important additional economic benefits to both the owner and lessee of a trash container.

The owner of the trash container achieves an additional benefit if advertising space can be sold on the transportable trash containers and the lessee can benefit from advertising products and services.

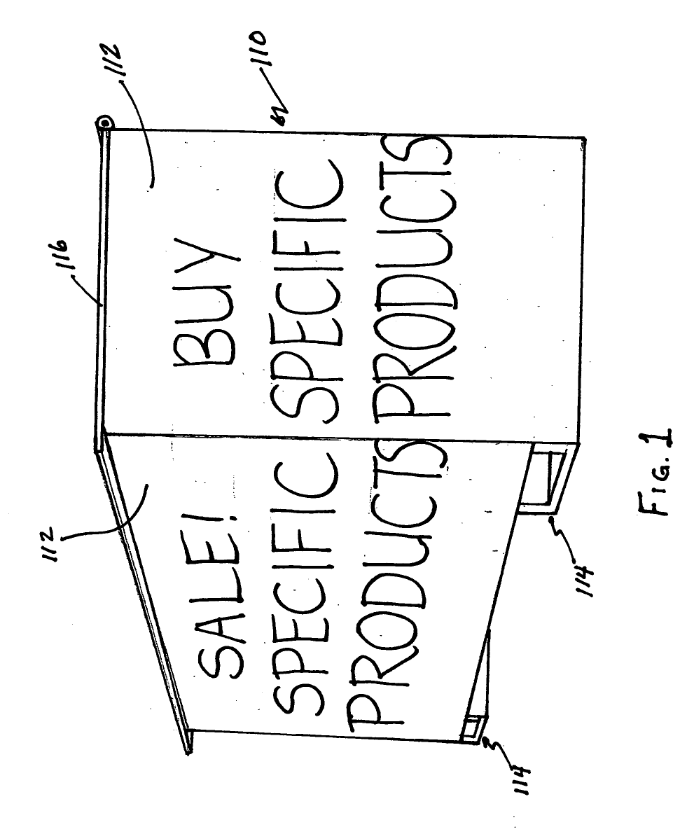

FIG. 1 shows a typical transportable trash container 110 having rails 114 connected to the bottom of the container 110 for handling and transportation of the container 110. Normally, the container 110 has a pivotal cover 116 for covering the container 110. The cover 116 may be opened to admit trash and closed to prevent the ingress of precipitation, animals and the like. Other commonly known types of transportable trash containers can be used with the present invention.

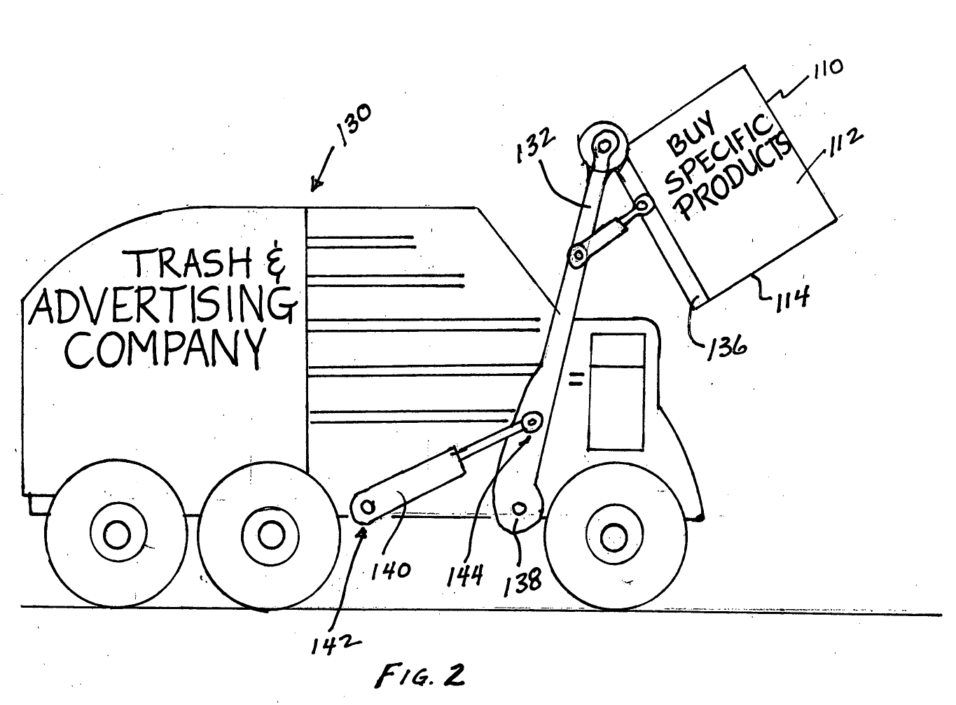

In FIG. 2, a special automotive vehicle 130 includes container transporting and emptying arms 132 having lifting forks 134 at one end 136 of the arms 132. The arms 134 are mounted on the vehicle 130 at the other end 138 for pivotal movement with respect to the vehicle 130. The arms 132 and forks 134 are moved with respect to the vehicle 130 by hydraulic rams 140 that are pivotally connected at one end 142 to the vehicle 130 and at the other end 144 to the arms 132.

In operation, the vehicle operator places the forks 134 into the rails 114 located on the bottom of the transportable trash container 110. The forks 134 engage the rails 114 of the container 110 and facilitate the lifting, transport and positioning of the container 110. The arms 132 and hydraulic rams 140 can move the forks 134 and container 110 to various positions. For example, the forks 134 can be positioned horizontally so that the container 110 is maintained in an upright position for transportation between locations or the arms 132 can be moved further upwardly where, due to the arcuate motion of the arms 132, the container 110 is inverted, the cover 116 opened by the force of gravity, and contents dumped into a closed container 146 mounted on the vehicle 130. The vehicle 130 is used to transport the trash in the closed container 146 to a permanent waste storage site.

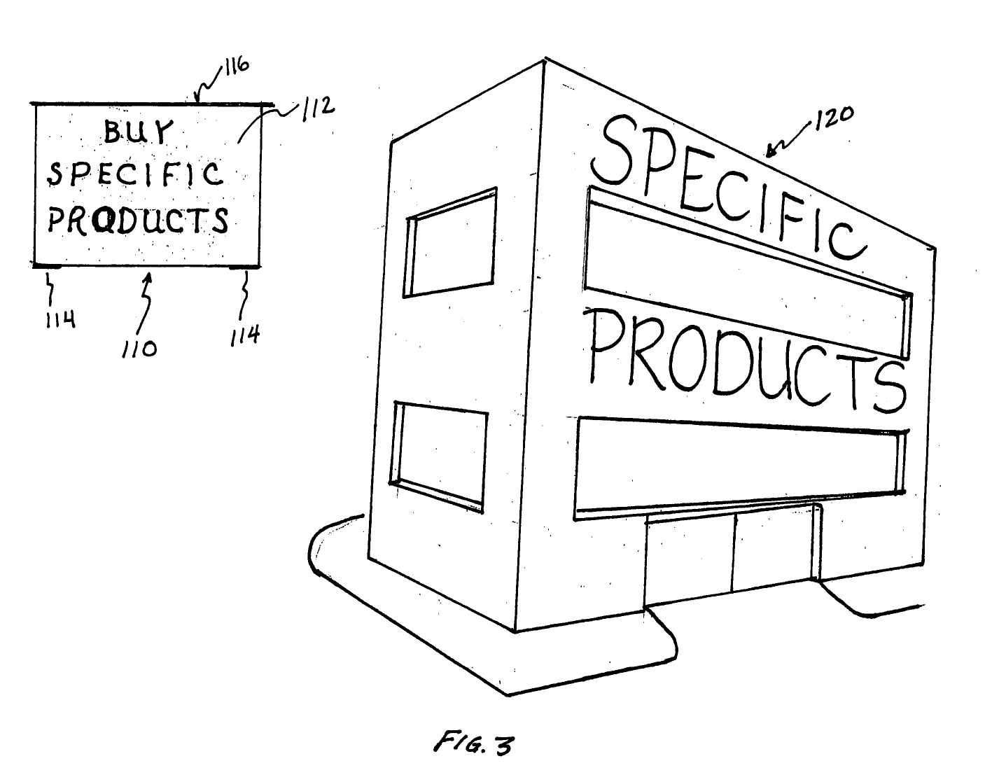

FIG. 3 illustrates that in accordance with the present invention, transportable trash containers 110 including advertising 112 may be placed near a commercial enterprise 120. The owner of the transportable trash container leases the container 110 for the temporary storage of trash generated by an enterprise 120 and licenses the use the container for advertising the enterprise, or the products or services offered by the enterprise 120 or another third enterprise.

Having thus described my invention and a preferred embodiment for the practice of the invention, I now claim:

1. A method of doing business comprising providing trash collection and advertising services including:
leasing a transportable trash container to a specific business for storing trash and providing advertising for said specific business,
moving the leased transportable trash container to a location where said container will be used to temporarily store trash generated in the conduct of the specific business;
placing an advertisement relating to such specific business, products or services delivered by said specific business on the transportable trash container; and
emptying the leased transportable trash container of accumulated trash periodically during the lease.
